(19) United States
(12) Patent Application Publication
(10) Pub. No.: US 2014/0365474 A1
(43) Pub. Date: Dec. 11, 2014

(54) SYSTEM AND METHOD FOR SHARING CONTENT OVER THE WEB

(71) Applicant: Doat Media Ltd., Tel Aviv (IL)

(72) Inventors: Rami KASTERSTEIN, Givataim (IL); Amihay BEN-DAVID, London (GB); Joey Joseph SIMHON, Ramat-Gan (IL); Amir TAICHMAN, Haifa (IL)

(73) Assignee: Doat Media Ltd., Tel Aviv (IL)

(21) Appl. No.: 14/468,894

(22) Filed: Aug. 26, 2014

Related U.S. Application Data
(63) Continuation-in-part of application No. 13/712,563, filed on Dec. 12, 2012.
Application No. 13/712,563 is a continuation-in-part of application No. 13/156,999, filed on Jun. 9, 2011.
Application No. 13/712,563 is a continuation-in-part of application No. 13/296,619, filed on Nov. 15, 2011.
Application No. 13/296,619 is a continuation-in-part of application No. 13/156,999, filed on Jun. 9, 2011.
Application No. 13/156,999 is a continuation-in-part of application No. 14/103,536, filed on Dec. 11, 2013.
Application No. 14/103,536 is a continuation-in-part of application No. 13/712,563, filed on Dec. 12, 2012.
(60) Provisional application No. 61/870,267, filed on Aug. 27, 2013.
(60) Provisional application No. 61/653,562, filed on May 31, 2012.
(60) Provisional application No. 61/354,022, filed on Jun. 11, 2010.
(60) Provisional application No. 61/468,095, filed on Mar. 28, 2011.
(60) Provisional application No. 61/822,376, filed on May 12, 2013.

(51) Int. Cl. G06F 17/30; H04L 29/06

(52) U.S. Cl. CPC G06F 17/30867; G06F 17/3089; H04L 65/403
USPC 707/722

(57) ABSTRACT

A system and method for sharing content over the web. The method comprises: receiving a request from a user via a first user device to share at least one content item with at least a second user device, the request includes at least a search term related to the at least one content item; determining an intent of the user respective of the at least a search term in the received request; searching for at least one web source capable of providing the at least one content item, wherein the search is performed using the determined user intent and the at least a search term; generating a dynamic folder; and storing, in the dynamic folder, the at least one content item provided by the search.

### CROSS-REFERENCE TO RELATED APPLICATIONS

This application claims the benefit of U.S. Provisional Application No. 61/870,267 filed Aug. 27, 2013. This application is also a continuation-in-part (CIP) of:

a) U.S. patent application Ser. No. 14/103,536 filed on Dec. 11, 2013, now pending, which claims the benefit of U.S. Provisional Patent Application No. 61/822,376 filed on May 12, 2013. The Ser. No. 14/103,536 Application is also a continuation-in-part of the below-referenced Ser. No. 13/712,563 Application;

b) U.S. patent application Ser. No. 13/712,563 filed on Dec. 12, 2012, now pending, which claims the benefit of U.S. Provisional Patent Application No. 61/653,562 filed on May 31, 2012. The Ser. No. 13/712,563 Application is also a continuation-in-part of the below-referenced U.S. patent application Ser. No. 13/156,999 and U.S. patent application Ser. No. 13/296,619 filed on Nov. 15, 2011, now pending; and,

c) U.S. patent application Ser. No. 13/156,999 filed on Jun. 9, 2011, now pending, which claims the benefit of U.S. Provisional Patent Application No. 61/468,095 filed on Mar. 28, 2011, and U.S. Provisional Patent Application No. 61/354,022 filed on Jun. 11, 2010. All of the applications referenced above are herein incorporated by reference.

### TECHNICAL FIELD

The present invention relates generally to methods for sharing content over the web and, more specifically, to systems and methods for sharing content over the web respective of users' intents.

### BACKGROUND

As the world wide web (WWW) continues to grow exponentially in size and content, the task of finding relevant and pertinent information has become increasingly complex. Upon finding such information, many users may need or want to share the information with another person, either instantly or, in some cases, at a future point in time. Current communication tools do not provide an easy and convenient way for a person to associate, share, and locate such information other than providing a universal resource locator (URL), also known as a link, to the information. Another solution for sharing information is to upload a file to a cloud-based storage unit and provide another person a link to access the storage unit.

However, users often wish to share content which includes more than one file, or which includes a subject of interest that many files relate to. In such cases, the related content may exist in different resources, thereby making the task of uploading the content complex, inconvenient, and, at times, impossible.

Moreover, providing links or using applications may yield improper or otherwise imperfect results when, for example, a link is provided from content displayed on a mobile device to a personal computer (PC).

It would therefore be advantageous to provide a solution that would allow users to conveniently share content across devices.

### SUMMARY

Certain disclosed embodiments include a method for sharing content over the web. The method comprises: receiving a request from a user via a first user device to share at least one content item with at least a second user device, the request includes at least a search term related to the at least one content item; determining an intent of the user respective of the at least a search term in the received request; searching for at least one web source capable of providing the at least one content item, wherein the search is performed using the determined user intent and the at least a search term; generating a dynamic folder; and storing, in the dynamic folder, the at least one content item provided by the search.

Certain disclosed embodiments also include a system for sharing content over the web. The system comprises: a processor; and a memory communicatively connected to the processor, the memory containing instructions that, when executed by the processor, configure the system to: receive a request from a user via a first user device to share at least one content item with at least a second user device, the request includes at least a search term related to the at least one content item; determine an intent of the user respective of the at least a search term in the received request; search for at least one web source capable of providing the at least one content item, wherein the search is performed using the determined user intent and the at least a search term; generate a dynamic folder; and store, in the dynamic folder, the at least one content item provided by the search.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system utilized to describe the embodiments for sharing content over the web;

FIG. 2 is a flowchart illustrating sharing of content over the web according to an embodiment;

FIG. 3 is a schematic block diagram of an intent detection unit according to an embodiment;

FIG. 4 is a flowchart illustrating detection of user intent according to an embodiment; and

FIG. 5 is a flowchart illustrating generation of a dynamic folder according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for sharing content over the web. A request is received from a user device to share content items with one or more other user devices. The search intent of a user who initiated the request is determined. One or more resources through which the content items can be provided to the user devices are selected in part based on the request. A dynamic folder accessible by the user devices is generated. Such folder may be placed in a centralized location and includes the content items or links thereto.

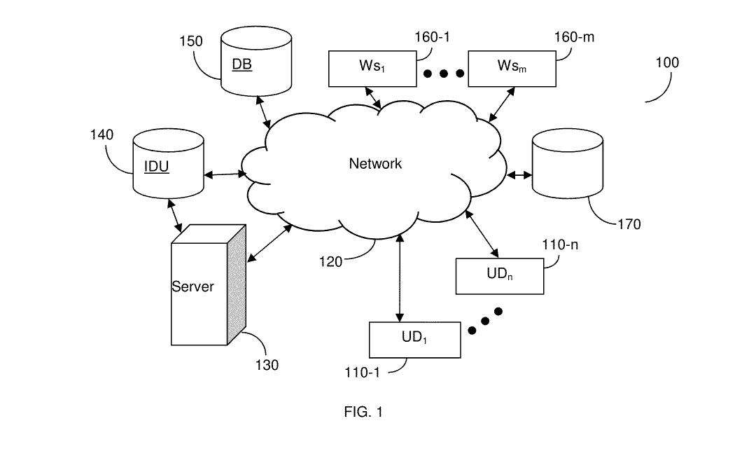

FIG. 1 shows an exemplary and non-limiting schematic diagram of a system 100 utilized to describe the various disclosed embodiments for sharing content over the web. A plurality of user devices 110-1 through 110-n (referred to hereinafter collectively as user devices 110 or individually as a user device 110, merely for simplicity purposes) are connected to a network 120. Each of the user devices 110 may be, but is not limited to, a smart phone, a mobile phone, a laptop, a tablet computer, a personal computer (PC), and so on. The network 120 may be, but is not limited to, a local area network (LAN), a wide area network (WAN), a metro area network (MAN), the world wide web (WWW), the Internet, a wired network, a wireless network, and the like, as well as any combinations thereof.

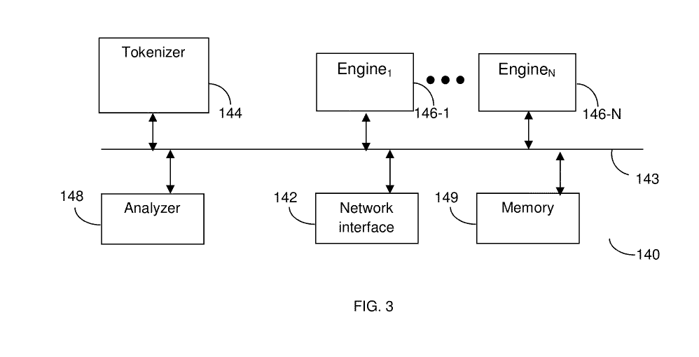

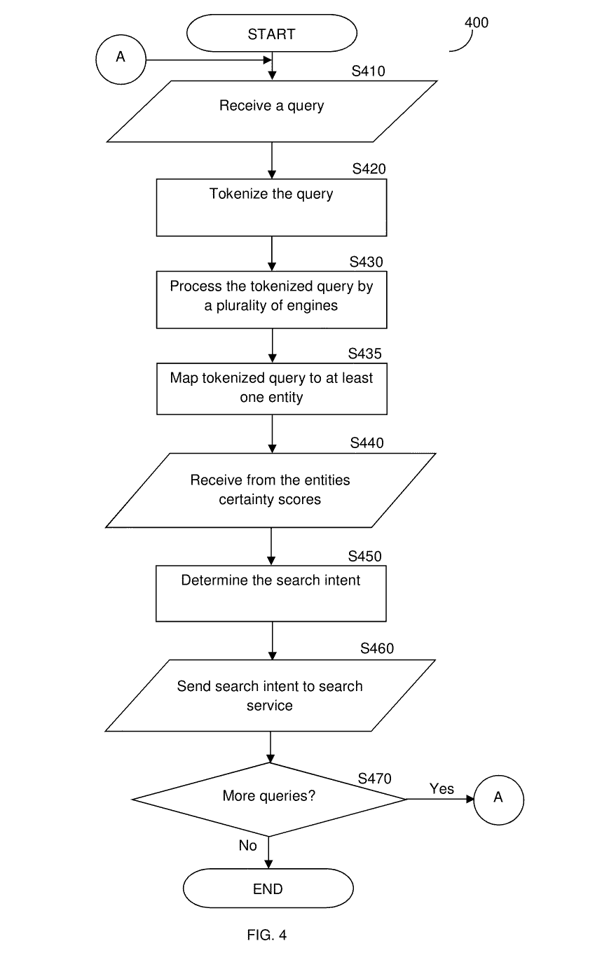

The user devices 110 are configured to communicate with a server 130 which is also communicatively connected to the network 120. The server 130 is configured to send the received content to and from an intent detection unit (IDU) 140. In an embodiment, the IDU 140 is integrated in the server 130. Operation of the IDU 140 is described in greater detail herein below with respect to FIG. 3. The user's search intent (hereinafter user intent) represents the type of actions the user wishes to allow other users to perform on the content for a certain period of time. For example, the user intent may represent the user's desire to view, download, and/or listen to a clip. Detection of user intent is described further herein below with respect to FIG. 4.

According to an embodiment, a user may be able to prevent one or more users form accessing restricted content. Restricted content may be, e.g., content designated by a user that may only be accessed by certain other users. As an example, a user may wish to share the restricted content with friends and family, but not with all other people that the user knows. As another example, a user may designate certain individuals that he or she wishes to share the content with, and all other users cannot access the restricted content. The IDU 140 is further configured to send the determined user intent to the server 130.

The system 100 may further include a database 150 for storing information related to the content, the user intent, prior user intents, and so on. A plurality of web sources 160-1 through 160-m (hereinafter referred to collectively as web sources 160 or individually as a web source 160, merely for simplicity purposes) are further connected to the network 120. A web source 160 may be for example, a web server, a media content streaming server, an application server, and other sources of information accessible through the network 120. The server 130 is configured to crawl through the one or more web sources 160 as well as through the user devices 110. Respective of the crawling and the user intent, the server 130 is configured to identify one or more resources from which the requested content can be provided.

According to an embodiment, when a plurality of resources is identified by the server 130, the resources may be prioritized by their relevance to the content or by one or more preconfigured parameters received from the user device 110. The relevance of a resource to content may be a measure of, but is not limited to, how likely the resource is to be an appropriate source of the content, how well the resource will deliver the content respective of other resources, and so on. A resource may be an appropriate source for content if, e.g., the resource will provide the content in a format that the receiving device is expecting, a format desired by the user that is sharing or receiving the content, and so on.

The appropriateness of a resource may be based on, e.g., one or more external parameters which characterize at least one of a user of a mobile device, the mobile device itself, and so on. The external parameters may include, but are not limited to, demographic information respective of the user, a location of the mobile device, a type of the mobile device (e.g., an operating system of the user device, hardware capability of the user device, etc.), and so on. For example, if an external parameter includes the user's age, then age-restricted applications that are not permitted based on the user's age may be determined to not be appropriate. As another example, if the operating system of the mobile device is iOS®, applications that are incompatible with iOS® are determined to not be appropriate.

As a non-limiting example of prioritizing applications based on relevance, if a user wishes to share a video clip about the television show Survivor® with another user who will view the content on a mobile device running iOS®, the eBay® application and the Youtube® application may be among the plurality of resources identified that are capable of delivering content. In this example, the user receiving the content wishes to view a video clip, and does not wish to purchase DVDs of the show. Accordingly, the user intent is determined to be related to viewing videos. Thus, the Youtube® application may be determined to be highly likely to deliver the content in an appropriate format, while the eBay® application may be determined to be unlikely to deliver the content in an appropriate format. As a result, the Youtube® application is determined to be more relevant than the eBay® application and, therefore, is prioritized over the eBay® application.

According to another embodiment, the server 130 is configured to generate a dynamic folder. In an embodiment, the dynamic folder is created in a dynamic folder repository 170. The dynamic folder repository 170 is communicatively connected to the network 120 and particularly is accessible by the user devices 110. The dynamic folder repository 170 may include a plurality of dynamic folders created in response to user requests to share content. Each folder may be uniquely identified based on, for example, an identifier of a user who initiated the request for sharing content. In another embodiment, a dynamic folder may be generated on, for example, a user device sending the sharing request and/or the server 130. Access restriction or permissions to the dynamic folders or systems hosting the folder are defined through access permission data.

A dynamic folder includes links to content items determined to be relevant to user intent. According to one embodiment, the server 130 may provide copies of content items in a dynamic folder rather than links thereto. Such provisions may occur when, e.g., the content is available through either the web sources 160 or through the user devices 110. According to yet another embodiment, related content may be provided instead of the selected content if the selected content is unidentified or otherwise unreachable. Related content may be, e.g., content which deals with similar subject matter, or content which features the same actor, character, and so on. As a non-limiting example, content which is related to the movie Rocky® may be, but is not limited to, other movies starring Sylvester Stallone, content involving boxing, content involving Philadelphia, and so on.

Respective of the content or links thereto, one or more visual representations are generated by the server 130. Such visual representations will be displayed on a user device accessing the dynamic folder. The visual representations may be, but are not limited to, any type of graphical symbol rendered and displayed in the dynamic folder over the display on the user device 120 such as, for example, an icon, a widget, and so on. If execution of the content is subject to a condition such as, for example, registration, payment, and so on, a link through which the condition can be met may be provided to the folder.

The server 130 is further configured to continuously check whether the contents placed in the dynamic folder are appropriate and, if necessary, to update the resources. The system 100 may further include an agent (not shown) installed locally on one or more of the user devices 110 that enables local crawling through content stored or otherwise available on the user devices 110 and linking to content that exists locally on the user devices 110. According to an embodiment, the system 100 is further configured to identify the type of the user devices 110, i.e., whether each user device 110 is a laptop, smart phone, and so on. In that embodiment, the type of a user device 110 is used to select a suitable resource for providing content. In another embodiment, the content placed in the dynamic folder is adapted to be compatible and accessible by the type of the user devices 110 accessing the folder. Various elements of the system 100 are further described in co-pending U.S. patent application Ser. No. 13/156,999, assigned to common assignee, which is hereby incorporated by reference for all that it contains.

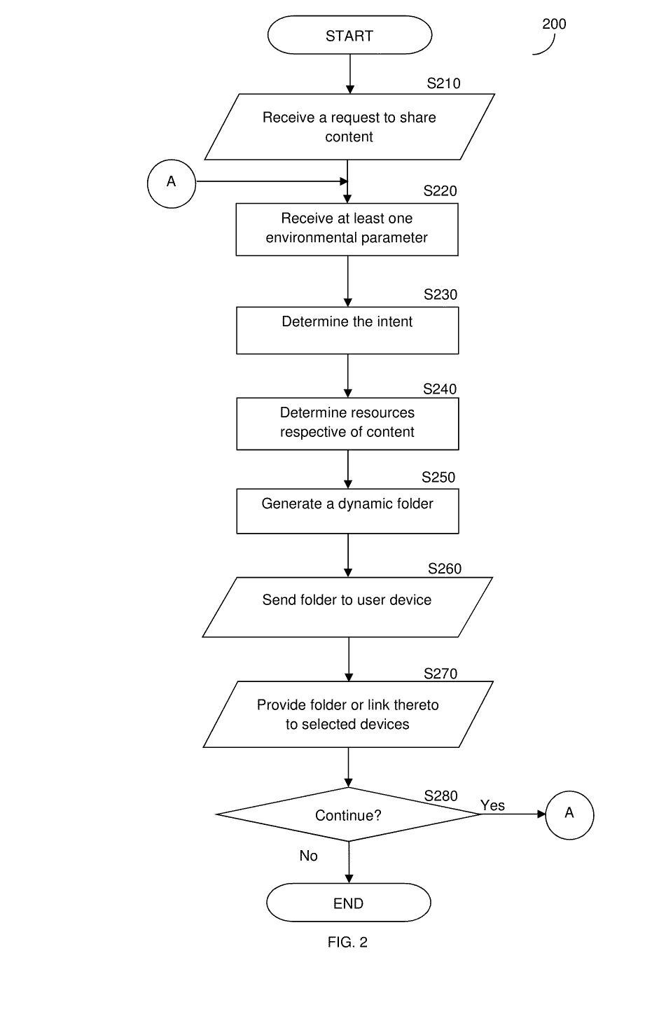

FIG. 2 is an exemplary and non-limiting flowchart 200 illustrating a method for sharing content over the web according to an embodiment. In S210, a request to share content with one or more selected user devices (e.g., one or more of the user devices 110) is received. In an embodiment, the request may be received by a server (e.g., the server 130). The request may be received as, but is not limited to, a query or a gesture. A gesture may be, but is not limited to, a scroll on a portion of a display, a press on a portion of a display, a tilt of a device (e.g., a user device 110), a response to the portion of the display, and so on. The request includes a keyword or a search term related to the content requested to be shared. According to another embodiment, in addition to the request to share content, one or more comments respective of the content may be received. Such comments may include, but are not limited to, ordering or reordering of a dynamic folder.

In S220, at least one environmental variable is received. In an embodiment, the environmental variable may be received by a server (e.g., the server 130). An environmental variable may be, but is not limited to, a location of a user device (e.g., a user device 110), a user device's rate of motion, a time of day, and so on. In one embodiment, a set of variables may be preconfigured as defined by, e.g., a system (e.g., the system 100) or a user. As a non-limiting example, a variable “home” may relate to the physical location of the user's home, while a variable “morning” may relate to times between 6 AM and 10 AM. In various embodiments, such preconfigured variables may relate to specific user intents respective of requests.

In addition to environmental variables, one or more personal variables associated with the user may be retrieved or received. Such personal variables may include, but are not limited to, a user profile, demographic information, a user's preferences, and so on. Such variables may be retrieved or received from, e.g., systems and/or databases that generate and/or maintain the variables.

In S230, based on the received variables, the user intent is determined. The received variables typically include one or more environmental variables and, in some embodiments, one or more personal variables. The user intent may represent the type of content, the content, and/or actions that may be of interest to a user at a current time period. In one embodiment, the intent is determined by monitoring at least the received variables or one or more variables that are determined to be monitored to determine any changes in variables that may, in turn, change the intent. Changed variables may be analyzed to determine the current intent of the user at any specific time. Determination of user intents is described further herein below with respect to FIG. 4.

As a non-limiting example, respective of the query “local restaurants,” environmental variables indicating the location of a user device and a time of day are received. In this example, the variable “morning” is associated with times between 6 AM and 10 AM, and the received time environmental variable indicates that the time is 7 AM. Respective of the variable “morning” and the query for “local restaurants,” the user intent is determined to be “find nearby restaurants that are open in the morning.”

As another non-limiting example, respective of the query “local restaurants,” an environmental variable indicating the user device's current location and a personal variable indicating that the user has a preference for sushi are received. Respective of the received variables, the user intent may be determined to be “find nearby sushi restaurants.”

As yet another non-limiting example, the environmental variable “location of the user device” may be monitored to track any changes in user intent. A user provides the query “electronics store.” At the time the query is initially provided, the user is in Pennsylvania. At that time, the user intent may be determined to be “find electronics stores in Pennsylvania.” The user subsequently moves to New York. Thus, the location of the user device changes. Accordingly, the user intent may be updated to “find electronics stores in New York.”

In S240, respective of the user intent, a search for appropriate resources is performed. In an embodiment, such a search may be performed through, but is not limited to, a web source (e.g., a web source 160) or a user device (e.g., a user device 110). The search is performed respective of appropriateness of resources to the selected user devices and/or to users of such devices. Appropriateness of resources is described further herein above with respect to FIG. 1.

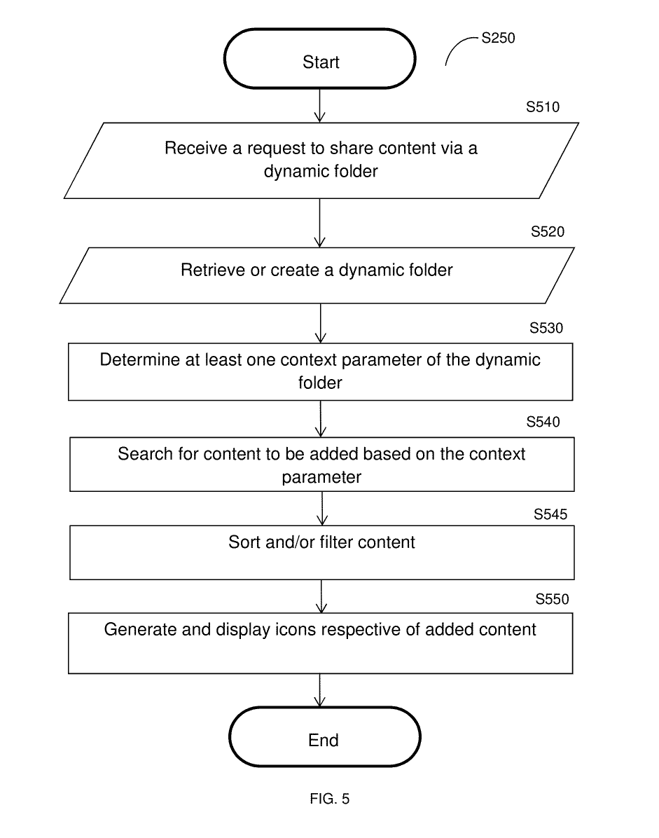

In S250, a dynamic folder is generated. The dynamic folder is accessible to the selected user devices. Generation of dynamic folders is described further herein below with respect to FIG. 5. Optionally, in S260, the dynamic folder may be provided to the user device for edits, comments, and/or application of filters. S260 may further include continuously searching for content respective of the user intent and, upon identification of related content, providing the content or links thereto through the dynamic folder.

In S270, the folder or a link thereto is provided to the selected devices. According to one embodiment, access permission data may be set. The access permission data defines the activities that other users are able to perform within the dynamic folder or system hosting the folder. Such activities may include, but are not limited to, viewing the content, editing the content, commenting on or in the content, and so on. According to another embodiment, different users may have different permissions respective of the access permission data that is received. The dynamic folder may be generated on, for example, a user device (e.g., the user device 110), a server (e.g., the server 130), and/or on a central repository accessible by the selected devices. In S280, it is checked whether additional requests have been received and, if so, execution continues with S210; otherwise, execution terminates.

As a non-limiting example, a request is received from a first device to share content related to Madonna with a second device. The user intent is determined to be related to the entertainer Madonna. Respective thereto, a search for content related to the entertainer Madonna is performed locally through the first device as well as through a plurality of web sources. Respective of the search, a dynamic folder is generated comprising one or more links to content related to the entertainer Madonna. In this example, such content includes songs performed by Madonna and video clips featuring Madonna. The links direct the user of a second device to one or more sources for the content which the second device can use such as, e.g., the Netflix® application or a Youtube® application for mobile devices when the second device is a mobile device. The dynamic folder is then provided to the second device.

FIG. 3 depicts an exemplary and non-limiting schematic diagram 300 of the IDU 140 according to an exemplary embodiment. The IDU 140 includes a network interface 142, a tokenizer 144, a plurality of engines 146-1 through 146-N, an analyzer 148, and a memory 149. The network interface 142 provides connectivity to the network 120 and is configured to receive queries from the server 130 or directly from a user device 110. The network interface 142 may further be used to communicate with the database 150 to retrieve information therefrom. The elements of the IDU 140 are communicatively coupled using a communication bus 143.

The tokenizer 144 is configured to tokenize an input query to units of information (tokens). The tokenizer 144 arranges the tokens in tokenized paths to enable efficient processing by the engine 146. Each token may be, but is not limited to, a word or a series of words, or a number or a series of numbers. According to one embodiment, the tokenizer 144 may also include a filtering unit (not shown) for filtering the input query. The input queries can be classified into three different types of queries: definitive, fuzzy, and noisy. A definitive query is short and mapped to known entities or keywords. A fuzzy query contains a combination of known entities and keywords that are not correlated to the known entities. Noisy queries cannot be mapped to known entities, or are long and complex. According to the disclosed embodiments, an entity is an “object” in the world that can be defined with known types and attributes. Entities may be, for example, products, people, locations, companies, music bands, popular keywords, applications, zip codes, and query components. Each entity can be associated with one or more classifications describing its essence. For example, an entity ‘Madonna’ can be associated with the classifications singer, actor, and celebrity.

The filtering process is designed to simplify at least fuzzy and noisy queries. The filtering process may include removing one or more unnecessary tokens (such as preposition words) from the query. As an example, if the received query is “where there in Tolsa”, the word “in” may be removed from the query if the token is determined to be unnecessary. A list of unnecessary tokens is defined in a semantic dictionary maintained in the database 150 or the memory 149.

The tokenized paths created by the tokenizer 144 are based on the fact that the coherent query typically includes a set of tokens (mapped to entities as defined above) that represent similar intents. According to one embodiment, any ambiguity between paths is resolved by using the most coherent and probable path among all possible tokenized paths. In one embodiment, a graph of connections between entities (e.g., singers connected to their songs) is utilized to evaluate the likelihood of a certain tokenized paths yielding the user's intended search result based on the connection of tokens (mapped to entities) in the same query. For example, the input query “madonna vogue” includes two tokens: “madonna” and “vogue”, where the tokenized path is that the entire query deals with music, rather than a Vogue magazine article (“Vogue” is both the name of a Madonna song and the title of a magazine).

Each engine of the plurality of engines 146 is configured to handle one or more different topics of interest. In one embodiment, a set of engines 146 are configured to map input tokenized paths or tokens (hereinafter tokenized queries) to entities. As noted above, entities are objects that can be defined using a set of attributes such as consumer goods, locations, keywords, mobile applications (apps), person names, questions, URLs, and so on.

As a non-limiting example, an engine 146 may be configured to handle locations, search for place names (cities, states, countries) in the tokenized query, and compute the probability that the user added a location to his or her input query. As another non-limiting example, an engine 146 that handles the names of people computes the probability that a given n-gram in the tokenized query is the name of an unknown person. Such an engine uses a frequency dictionary for common names versus common words, and common last name suffixes. In the fields of computational linguistics and probability, an n-gram is a contiguous sequence of n items from a given sequence of text or speech.

As another non-limiting example, an engine 146 that handles URLs is configured to include a list of URLs, domain names, and websites, and to compute the probability that the tokenized query includes a website name. As another non-limiting example, an engine 146 computes the probability that the tokenized query includes a question word, thereby determining the probability that the entire input query is a question. This determination is performed using pattern matching.

According to one embodiment, the probability may be computed based on at least one of: the frequency of appearance of the tokenized query within the entities by the engines, the correlation of the tokenized query to the entities, the matching between each of the tokens to the entities, the matching of the tokenized query to a plurality of search results received from an external search engine, the correlation to trend reports, and combinations thereof. As noted above, entities represent topics of interests.

The engines 146 are periodically updated with relevant content and are therefore consistent with the trends related to the respective topics. As a non-limiting example, the entities are updated by periodically downloading an index of entities from external sources (e.g., freebase.org) and names related mobile apps that can be periodically downloaded from central repositories of applications such as, e.g., AppStore®.

In one embodiment, trends or popularity reports of certain keywords or queries are retrieved from external sources. Such reports can be input to engines 146 and can be utilized in part to compute the probability of a certain entity. For example, a trend report shows that a keyword “JFK airport” is currently trendy, so the probability computed for the location JFK airport would be higher than the probability computed for the person President John F. Kennedy.

Each engine of the plurality of engines 146 then provides an output respective of the tokenized query. Such output includes the mapped entity from the engine 146 and a certainty score for the tokenized query based on the probability computed for the entity handled by a respective engine. That is, each certainty score reflects the matching of the tokenized query to the topic which the corresponding engine handles. In an exemplary embodiment, the certainty score is an integer number between 0 and 10. In one embodiment, a certainty score that does not exceed a predefined threshold is not output by the engine 146.

The outputs of the engine 146 are analyzed by an analyzer 148 and the search intent is determined respective of the analysis. The analysis of the analyzer 148 may include: a statistical analysis, a semantic analysis, analysis of the user experience, and combinations thereof. The statistical analysis determines the co-occurrence of the tokens within the topics of interest of the engine. The semantic analysis determines at least one of: the type of each of the one or more tokens, the correlation between each of the tokens and the topic of interest of the engine, and a combination thereof.

The statistical analysis is performed to determine, based on the certainty scores, which entities would best describe the search intent of an input query. This may include statistically combining the outputs from engines 146. In another embodiment, the statistical analysis including computing an average over the received certainty scores and considering entities with certainty scores over the computed average. The semantic analysis determines which of the combination of tokens mapped to entities describes a coherent query (or phrase).

The user intent is sent to the server 130 in order to provide the user with appropriate search results. It should be noted that each of the units may include a processor coupled to a memory (both are not shown).

As a non-limiting example, the words “March madness” are received as a query by the network interface 142. The query is tokenized by the tokenizer 144 to the tokenized queries “March,” “madness,” and “March madness.” The tokenized queries are then sent to a plurality of engines 146. An engine (e.g., engine 146-1) that handles dates will provide a high certainty score (e.g., 10) for the word “March” and the certainty of this word as the 3rd Month of the year, but this engine 146-1 will not provide an output for the tokenized queries “madness” and “March Madness” (or otherwise provide a certainty score below a predefined threshold). An engine (e.g., engine 146-2) that handles a music entity will provide a high certainty score (e.g., 7) for the word “madness” and the certainty of this word as the name of a Music band, but engine 146-2 will not provide an output for the tokenized queries “March” and “March Madness.” An engine (e.g., engine 146-3) that handles basketball will output a high certainty score (e.g., 10) for the tokenized query “March Madness” and the certainty of this combination of words as a basketball related phrase. Respective thereto the search intent is determined to be basketball, as a coherent query is comprised of entities that best represent the intent.

One exemplary implementation of IDU 140 can be found in co-pending U.S. patent application Ser. No. 14/103,536, assigned to common assignee, which is hereby incorporated by reference for all that it contains.

FIG. 4 depicts an exemplary and non-limiting flowchart 400 of a method for detecting a search intent of a user (user intent) submitting a search query according to one embodiment. In S410, a query, or a portion thereof, is received from a user device, for example the user device 110. The input query can be a text query or a voice query, wherein a text query would include a free text query and a structured query. In an embodiment, the user device is a hand held device. Therefore, in that embodiment, the user tends to type shorter queries as it is often inconvenient to type long phrases using hand held devices.

In S420, the received query is tokenized to one or more tokenized queries. A tokenized query may be any combination of tokens broken from the input query. A token may be a word or phrase that appears in the input query. In an embodiment, S420 is performed by a tokenizer (e.g., the tokenizer 146). In S430, the tokenized queries are input to one or more engines (e.g., the plurality of engines 146-1 through 146-N). In S435, each engine computes the probability that a tokenized query is mapped to at least an entity that the engine is configured with. An entity represents a topic of interest. Various examples of engines and their entities are discussed above. The probability computation is realized by a certainty score.

In S440, each of the engines provides at least one entity together with a certainty score. As an example, the tokenized query ‘madonna’ can be mapped to the entities: ‘musician’ and ‘religious figure.’ As noted above, in an embodiment, certainty scores below a predefined threshold are not output by the engines. In S450, at least a statistical analysis, a semantic analysis, or both is performed on at least the certainty scores and entities received from the engines to determine the search intent of the user. In S460, the determined search intent is returned to a search server. In an embodiment, the tokenized queries and the search intent are saved in, for example, a memory (e.g., the memory 149). In S470, it is checked whether a new query is received, and if so execution continues with S410; otherwise, execution terminates.

Determination of intent respective of environmental and/or personal variables is described further in co-pending U.S. patent application Ser. No. 13/712,563 assigned to common assignee, which is hereby incorporated by reference for all that it contains.

FIG. 5 is an exemplary and non-limiting flowchart S250 illustrating generation of a dynamic folder according to an embodiment. In S510, a request to share content via a dynamic folder is received. In S520, a dynamic folder is retrieved or created. In an embodiment, folders may be identified as either being or not being dynamic folders. In such an embodiment, only folders identified as being dynamic folders may be retrieved. If, for example, no folders have been identified as dynamic folders, a dynamic folder may be created. In another embodiment, the user may choose whether to retrieve an existing dynamic folder or to create a new dynamic folder.

In S530, at least one context parameter of the dynamic folder is identified. According to an exemplary embodiment, a context parameter may be, for example, the name of the dynamic folder. In another exemplary embodiment, the contents of the dynamic folder may be analyzed to identify the context parameter(s). In such an embodiment, the category of each application of such content may be determined and, based on the categories of the majority of the applications of such content, the context parameters may be identified. Categories may include, but are not limited to, “games” for gaming applications, “music” for audio applications, “videos” for movies, television, and other video content, and so on.

In yet another embodiment, identification of the context parameter may be performed by an agent or by a native application installed on a user device (e.g., the user device 110). According to this embodiment, identification of the context parameter may be performed offline, with no connectivity to a network (e.g., the network 120).

In S540, content to be added to the dynamic folder respective of the at least one context parameter is searched for. Optionally, in S545, the content found during the search may be sorted and/or filtered based on, but not limited to, relevance of the content, appropriateness of the resource or content, and so on. In one embodiment, the sorting and/or filtering is performed using at least one external parameter. External parameters are described further herein above with respect to FIG. 1.

In S550, icons respective of the added content are generated and displayed on a user device (e.g., the user device 110). An icon may represent an application or a shortcut to an application. In an embodiment, web applications may be represented by different icons from the icons representing native applications. As a non-limiting example, web applications may be represented by round icons, while native applications may be represented by square icons. It should be noted that an icon may be any type of graphical symbol rendered and displayed over the display of the user device. Clicking or tapping on the icon activates the respective application or provides a link to the selected content. In one embodiment, an icon may be in a form of a widget or a gadget that can activate and/or provide a link to the content. In another embodiment, the user may be requested to authorize or authenticate a particular placement of icons in the dynamic folder prior to the placement.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

Although some benefits and advantages of the preferred embodiments are mentioned, the scope of the disclosure is not intended to be limited to particular benefits, uses, or objectives. Rather, embodiments of the disclosure are intended to be broadly applicable to different wireless technologies, system configurations, networks, and transmission protocols, some of which are illustrated by way of example in the figures and in the description.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the principles and novel features disclosed herein.

What is claimed is:

1. A method for sharing content over the web, comprising:
receiving a request from a user via a first user device to share at least one content item with at least a second user device, the request includes at least a search term related to the at least one content item;
determining an intent of the user respective of the at least a search term in the received request;
searching for at least one web source capable of providing the at least one content item, wherein the search is performed using the determined user intent and the at least a search term;
generating a dynamic folder; and
storing, in the dynamic folder, the at least one content item provided by the search.

2. The method of claim 1, further comprising:
generating a visual representation for the at least one content item provided by the search, wherein the at least one content item is any one of: a copy of the at least one content item, and a link to the at least one content item; and
displaying each visual representation in the dynamic folder.

3. The method of claim 1, wherein generating the dynamic folder further comprising creating the dynamic folder on any one of: the first user device, and a centralized location.

4. The method of claim 3, wherein generating the dynamic folder further comprising setting access permission data, wherein the access permission data defines at least one action that a user of the second user device can perform respective of the dynamic folder.

5. The method of claim 4, wherein the at least one action is at least one of: viewing the content item, editing the content item, and commenting on the content item.

6. The method of claim 1, wherein the request is received as at least one of: a query, and a gesture detected over a portion of a display on the first user device.

7. The method of claim 2, further comprising:
continuously checking whether each link to the at least one content item is appropriate for providing the content.

8. The method of claim 1, further comprising:
identifying the type of the second user device; and
adapting the at least one content item to be accessible to and compatible with the type of the second user device.

9. The method of claim 1, further comprising:
receiving at least one environmental variable from the first user device; and
determining the user intent respective of the at least one environmental variable and the search term.

10. The method of claim 9, further comprising:
receiving at least one personal variable; and
determining the user intent based on the at least one personal variable, the search term, and the at least one environmental variable.

11. A non-transitory computer readable medium having stored thereon instructions for causing one or more processing units to execute the method according to claim 1.

12. A system for sharing content over the web, comprising:
a processor; and
a memory communicatively connected to the processor, the memory containing instructions that, when executed by the processor, configure the system to:
receive a request from a user via a first user device to share at least one content item with at least a second user device, the request includes at least a search term related to the at least one content item;
determine an intent of the user respective of the at least a search term in the received request;
search for at least one web source capable of providing the at least one content item, wherein the search is performed using the determined user intent and the at least a search term;
generate a dynamic folder; and
store, in the dynamic folder, the at least one content item provided by the search.

13. The system of claim 12, wherein the system is further configured to:
generate a visual representation respective for the at least one content item provided by the search, wherein the at least one content item is any one of: a copy of the at least one content item, and a link to the at least one content item; and
display each visual representation in the dynamic folder.
display each visual representation.

14. The system of claim 12, wherein the system is further configured to:
create the dynamic folder on any one of: the first user device, and a centralized location.

15. The system of claim 14, wherein the system is further configured to set access permission data, wherein the access permission data defines at least one action that a user of the second user device can perform respective of the dynamic folder.

16. The system of claim 15, wherein the at least one action is at least one of: viewing the content item, editing the content item, and commenting on the content item.

17. The system of claim 12, wherein the request is received as at least one of a query, and a gesture detected over a portion of a display on the first user device.

18. The system of claim 13, wherein the system is further configured to:
continuously check whether each link to the at least one content item is appropriate for providing the content.

19. The system of claim 12, wherein the system is further configured to:
identify the type of the at least a second user device; and
adapt the at least one content item to be accessible to and compatible with the type of the second user device.

20. The system of claim 12, wherein the system is further configured to:
receive at least one environmental variable from the first user device; and
determine the user intent respective of the at least one environmental variable and the search term.

21. The system of claim 20, wherein the system is further configured to:
receive at least one personal variable; and
determine the user intent based on the at least one personal variable, the search term, and the at least one environmental variable.
